(19) United States
(12) Patent Application Publication
(10) Pub. No.: US 2016/0232415 A1
(43) Pub. Date: Aug. 11, 2016

(54) DETECTION DETECTION OF CELL PHONE OR MOBILE DEVICE USE IN MOTOR VEHICLE

(71) Applicants: ISRAEL L'HEUREUX, MONACO (MC); MARK D. ALLEMAN, PORTLAND, OR (US)

(72) Inventors: ISRAEL L'HEUREUX, MONACO (MC); MARK D. ALLEMAN, PORTLAND, OR (US)

(21) Appl. No.: 14/854,010

(22) Filed: Sep. 14, 2015

Related U.S. Application Data
(63) Continuation-in-part of application No. 13/210,535, filed on Aug. 16, 2011, now Pat. No. 9,137,498.

(51) Int. Cl. G06K 9/00; G06T 7/40; G06T 7/00

(52) U.S. Cl. CPC G06K 9/00845; G06T 7/0085; G06T 7/004; G06T 7/408; G06K 9/00785; G06T 7/0022; G06T 2207/30268; G06T 2207/30196

(57) ABSTRACT

Embodiments for the detection of mobile device use in a motor vehicle are disclosed. As one example, a system and method are disclosed in which an image of a scene is captured via a camera. The presence of a graphical display of a mobile device is detected within the scene by processing the image to identify a signature pixel characteristic indicative of a graphical display in a portion of the scene corresponding to a driver's position within a vehicle frame of reference. An indication of a positive detection of the graphical display is output by the system.

### CROSS REFERENCE TO RELATED APPLICATIONS

This application is a continuation-in-part of U.S. patent application Ser. No. 13/210,535, filed Aug. 16, 2011 and issuing Sep. 15, 2015 as U.S. Pat. No. 9,137,498, the entire disclosure of which is herein incorporated by reference for all purposes.

### BACKGROUND

Local, state, and federal governments have instituted laws regarding the use of mobile computing devices such as cell phones, handheld computers, media players, etc. by drivers of motor vehicles. Such laws aim to increase motor vehicle safety, often by prohibiting use of mobile devices while operating a motor vehicle. Some uses mobile devices are apparent from outside of the motor vehicle, particularly if the driver has the mobile device raised to the driver's ear as typically performed during a voice call. Other uses, however, may be less apparent from outside of the motor vehicle, particularly if the driver discreetly uses the mobile device below the vehicle window, such as on the driver's lap. Discreet use of mobile devices by drivers may increase as the functionality of these devices expands beyond voice calls to include wireless Internet access, electronic games, media players, etc.

### SUMMARY

Embodiments for the detection of mobile device use in a motor vehicle are disclosed. As one example, a system and method are disclosed in which an image is captured of a vehicle being operated on a public roadway. A location is determined of a driver's seat region of the vehicle within the image. The presence of an illuminated graphical display is detected in the driver's seat region of the vehicle in the image. The presence of the graphical display may be detected by processing the image to identify a signature pixel characteristic indicative of a graphical display in the driver's seat region of the vehicle in the image. The indication of a positive detection of the graphical display may be output. Claimed subject matter, however, is not limited by this summary as other implementations are disclosed by the following written description and associated drawings.

### BRIEF DESCRIPTION OF DRAWINGS

FIG. 1 is a schematic diagram depicting an example system for detection of a driver's mobile device use while operating a motor vehicle according to one embodiment.

FIG. 2 is a schematic diagram depicting an example image captured of a mobile device detected within a motor vehicle.

FIG. 3 is a flow diagram depicting an example method for detecting the presence of a graphical display of a mobile device within a vehicle.

FIG. 4 is a schematic diagram depicting an example system including further aspects of the example system of FIG. 1.

FIG. 5 is a schematic diagram depicting a software architecture for a computer vision program that may be implemented by the computing device of the system of FIG. 4.

FIG. 6 is a schematic diagram depicting perspective correction and background removal by the computer vision program of FIG. 5.

FIG. 7 is a schematic diagram depicting wheel, body, side window, and B-pillar detection by the computer vision program of FIG. 5.

FIG. 8 is a schematic diagram depicting front driver's side window detection by the computer vision program of FIG. 5, with a display being identified within the front driver's side window.

### DETAILED DESCRIPTION

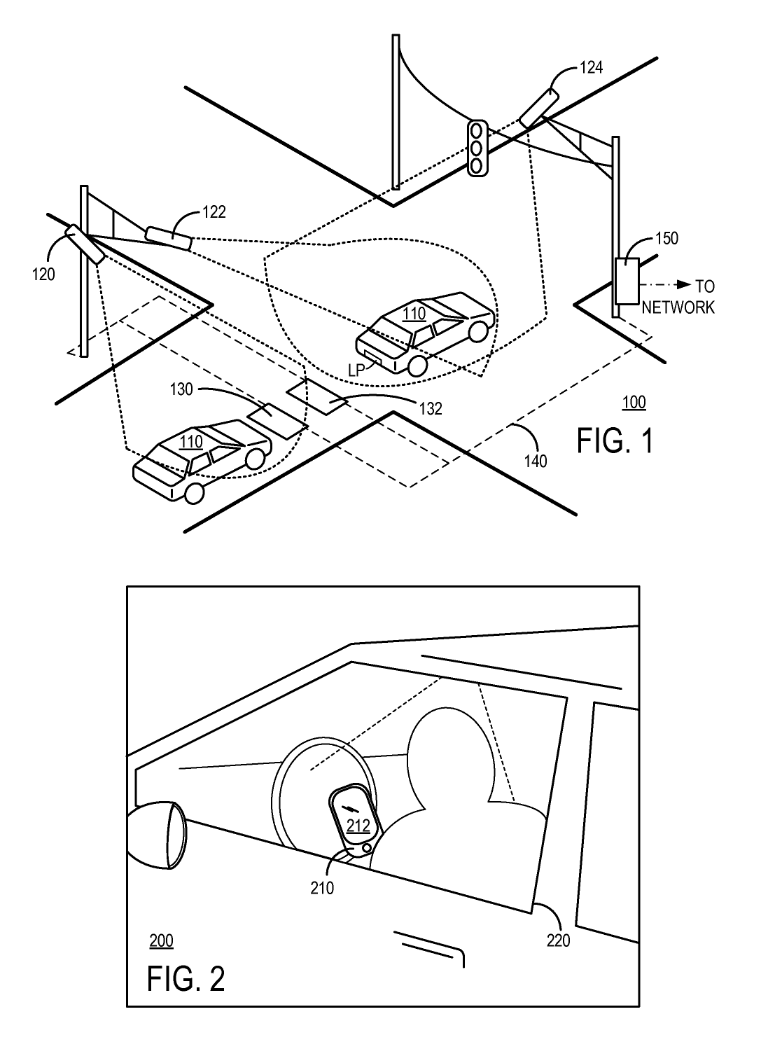

FIG. 1 is a schematic diagram depicting an example system 100 for detection of a driver's mobile computing device (i.e., mobile device) use while operating a motor vehicle 110 according to one embodiment. System 100 may include one or more cameras such as camera 120 positioned to capture an image of a driver's side of motor vehicle 110 while the motor vehicle is being operated on a public roadway. FIG. 2 is a schematic diagram depicting a non-limiting example image 200 that may be captured by camera 120 of a mobile device 210 having a graphical display 212 detected within a motor vehicle.

System 100 may include a computing device 150 configured to receive an image from camera 120, and process the image to identify a graphical display of a mobile device being operated by the driver of the motor vehicle. As one example, computing device 150 may be configured to process the image captured by camera 120 by detecting a signature pixel characteristic selected from a group consisting of hue, value, chroma, brightness, and luminosity. Computing device 150 may be configured to process the image by identifying the signature pixel characteristic in each of a plurality of contiguous pixels covering at least a threshold area within the image. While computing device 150 is depicted in FIG. 1 nearby camera 120, in some implementations, computing device 150 may be located at a remote location from camera 120 and may communicate with camera 120 via a communication network.

FIG. 1 further depicts how system 100 may additionally include cameras 122 and 124. Cameras 122 and 124 may be configured to capture images from a different perspective than the images captured by camera 120. The different perspective of the cameras may enable a license plate of the vehicle to be visible in images captured by cameras 122 and/or 124 if not already visible in the images captured by camera 120.

System 100 may include one or more sensors such as sensors 130 and 132 configured to sense predetermined positions of motor vehicle 110. Sensors 130 and/or 132 may take the form of inductive loop sensors that sense the vehicle's presence at a particular location on the roadway. Alternatively or additionally, one or more sensors may take the form of optical sensors that detect the presence of the vehicle at a particular location. As one example, an optical sensor may be integrated with a camera system also including a camera, such as camera 120, 122, or 124. In some embodiments, the cameras 120, 122, and 124 may be additionally configured as depth cameras that are able to detect the distance of various objects from the camera, which distance information may be used by computing device 150 to determine that the vehicle is at the particular location.

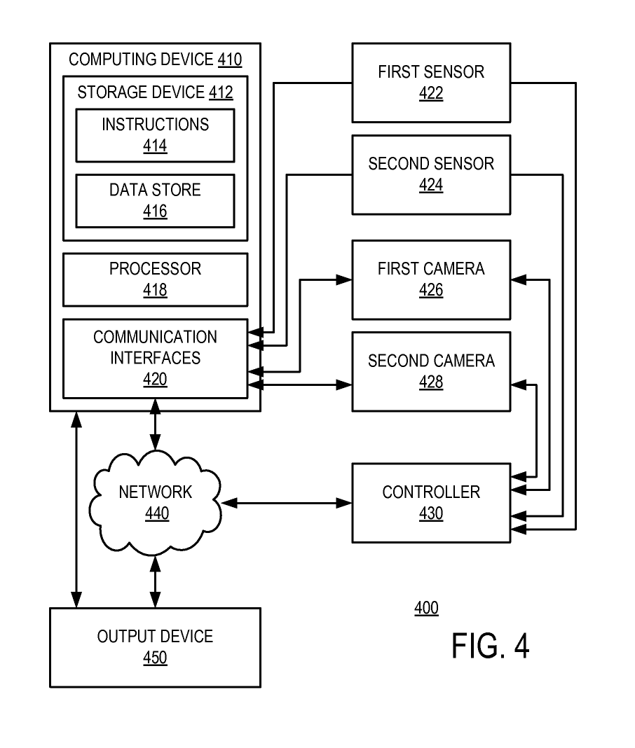

Computing device 150 or a separate controller (discussed in greater detail with reference to FIG. 4) may be configured to receive a signal from sensor 130 and/or sensor 132 indicating that the motor vehicle is in a predetermined position, and in response to the signal, send a signal to a select one or more of cameras 120, 122, 124 to cause the camera or cameras to capture an image of the vehicle. Computing device 150 or alternatively the separate controller may be configured to associate meta data with the image including, for example, location and time. Computing device 150 or alternatively the separate controller may be configured to send image data including images captured by one or more of cameras 120, 122, 124 to a remote computing device via a communications network, for example, to be presented to a government agent.

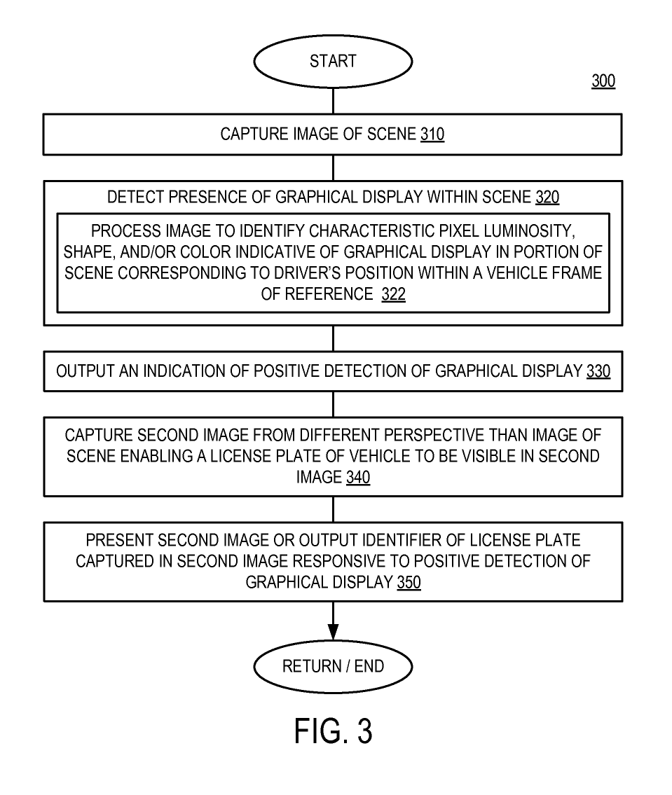

FIG. 3 is a flow diagram depicting an example method 300 for detecting the presence of a graphical display of a mobile device within a vehicle. As one example, method 300 may be performed by previously described computing device 150 of FIG. 1. Accordingly, method 300 may be implemented as instructions executable by a processor of a computing device, or by processors of multiple coordinated computing devices.

At 310, the method may include capturing an image of a scene. The image of the scene may be captured responsive to satisfaction of a trigger condition. The trigger condition may indicate the presence of the vehicle within the scene. For example, the trigger condition may be satisfied by a signal received at a computing device or controller from one or more sensors. As previously discussed, a sensor may include an inductive loop sensor, an optical sensor, or other suitable sensor. However, as an alternative to utilizing a trigger condition, the image of the scene may be one of a plurality of images of a video obtained from one or more video cameras that monitor the scene.

At 320, the method may include detecting the presence of a graphical display (e.g., of a mobile device) within the scene. For example, at 322, the method may include processing the image to identify a signature pixel characteristic that includes one or more of a hue, value, chroma, brightness, and/or luminosity. Processing the image may include applying edge detection and/or shape recognition algorithms to the image to identify characteristic shape of the graphical display and/or applying a filter to the image to identify the signature pixel characteristic. For example, a positive detection of the graphical display may be identified if one or more of a target hue, chroma, brightness, and/or luminosity values or particular combinations thereof are present within the image.

The edge detection algorithm may, for example, determine that a signature pixel characteristic such as high luminosity or a characteristic hue within a predefined range exists in the driver's seat region of the image. The high luminosity or pixels of characteristic hue are then compared to surrounding pixels in adjacent regions of the image, to determine whether the brighter/characteristically colored pixels differ from pixels in adjacent portions of the image by greater than a predetermined luminosity or hue difference threshold. If so, then the edge detection algorithm may also determine whether the high luminosity or characteristic hue pixels only appear within a border that has an aspect ratio that is within a predetermined range of target aspect ratios. This predetermined range of target aspect ratios may be, for example, within 10% of 4:3, for example.

In some implementations, the image may be further processed by identifying a target region of the image at which the driver's side window of the motor vehicle is located. The target region may be identified by extracting features of the motor vehicle including detected wheels and/or outline of the vehicle, and locating the estimated position of the driver's side window based on the extracted features. For example, edge detection, shape recognition, and/or other suitable image processing techniques may be applied to the image to identify elements of a motor vehicle and/or the graphical display located within the motor vehicle. As a non-limiting example, the graphical display may be identified by searching for an illuminated trapezoidal shape within the image relative to a darker geometric region representative of a window of the vehicle. Further processing of the image may be performed to identify whether one or more of the driver's fingers are partially obstructing the graphical display, which may be further indicative of active use of the graphical display by the driver.

At 330, the method may include outputting an indication of a positive detection of the graphical display. The indication may be output by presenting the image of the scene via a graphical display or transmitting the image to a remote computing device for inspection by personnel. Outputting the indication may include mailing the image of the scene to a mailing address associated with the vehicle along with a government issued citation. In some implementations, the method at 322 and/or 330 may further include detecting the driver's position within the vehicle frame of reference by processing the image to identify a window of the vehicle, and outputting the indication of the positive detection only if the graphical display is present within an interior region of the window corresponding to the driver's position within the vehicle frame of reference.

At 340, the method may include capturing a second image from a different perspective than the image of the scene. The different perspective may enable a license plate of the vehicle to be visible in the second image. For example, a first camera may be used to capture an image of the driver's side of the motor vehicle, and a second camera may be used to capture an image of the motor vehicle from a front or rear side of the motor vehicle. These images may be captured at the same time or at different times relative to each other. A sensor output indicating another triggering condition may be used to initiate capture of the second image for identifying a license plate of the vehicle.

At 350, the method may include presenting the second image or outputting an identifier of the license plate captured in the second image responsive to positive detection of the graphical display. For example, image data including the second image may be transmitted to a remote computing device for presentation to personnel.

FIG. 4 is a schematic diagram depicting an example system 400 including further aspects of the example system 100 of FIG. 1. Hence system 400 may depict a non-limiting example of system 100. System 400 includes computing device 410, which may correspond to previously described computing device 150.

Computing device 410 includes a storage device 412 having instructions 414 and data store 416 stored thereon. Computing device 410 includes a processor 418. Instructions 414 may be executable by processor 418 to perform one or more of the methods, processes, and operations described herein. Instructions 414 may take the form of software, firmware, and/or suitable electronic circuitry. Computing device 410 may include a communication interface 420 to facilitate wired and/or wireless communications with other components of system 400. [0022] System 400 includes a first camera 422 and a second camera 424. System 400 includes a first sensor 426 for triggering first camera 422, and a second sensor 428 for trigger second camera 424. Sensors 426 and 428 may take the form of induction loop sensors, optical sensors, etc. Cameras 422 and 424, and sensors 426 and 428 may be remotely located from computing device 410 in some implementations. For example, system 400 may include a controller 430 located nearby cameras 422 and 424, and sensors 426 and 428 that is physically separate from computing device 410. Controller 430 may receive signals from sensors 426 and 428, send signals to cameras 422 and 424 in response thereto, and receive respective images from cameras 422 and 424. Controller 430 may itself take the form of a computing device.

In some implementations, controller 430 may transmit images captured by cameras 422 and 424 to computing device 410 via communication network 440 for processing of the images at computing device 410. Hence, in some implementations, capture of images may be managed by controller 430 while image processing is performed by computing device 410. In other implementations, such as depicted in FIG. 1, computing device 410 may manage the capture of images and perform image processing, and controller 430 may be omitted.

Computing device 410 may output image data including the captured images (e.g., in raw and/or processed states) to a graphical display 450. The graphical display may be located at or form part of a remote computing device from computing device 410, in which case computing device 410 may transmit image data to graphical display 450 via communication network 440. For example, graphical display 450 may be located at government offices remote from the public roadway monitored by the cameras. Alternatively, graphical display 450 may be located at or form part of computing device 410 in some implementations. For example, controller 430 may be located at or nearby the cameras and/or sensors, and computing device 410 may be located at government offices remote from the public roadway.

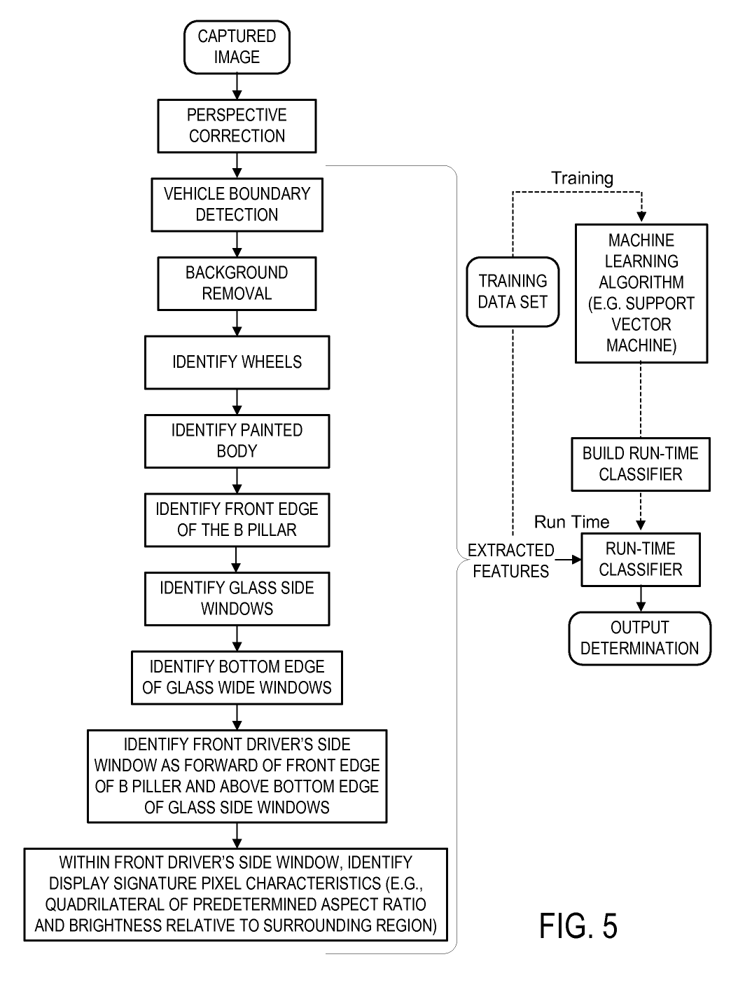

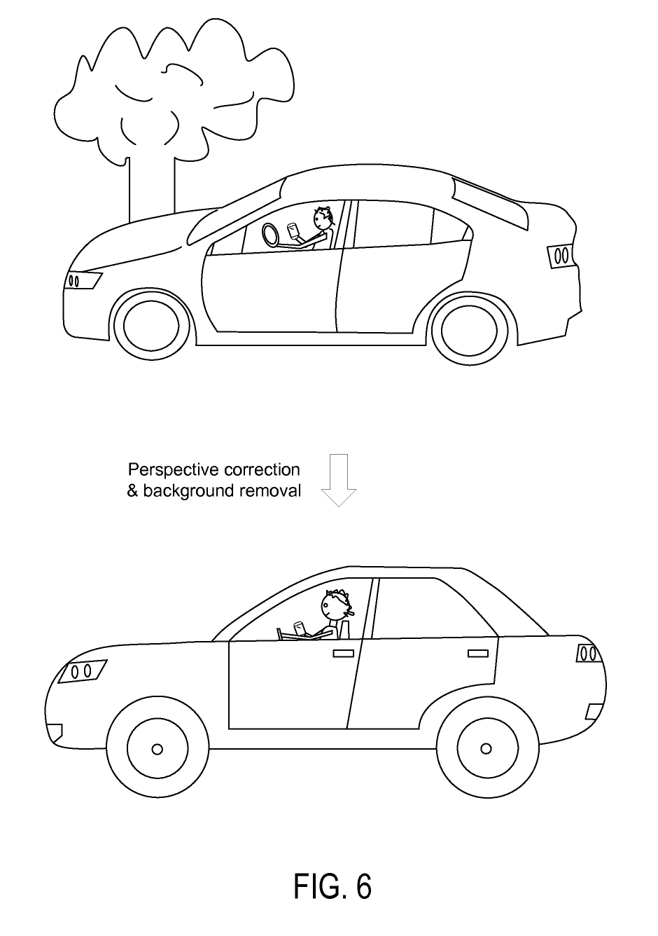

Turning now to FIG. 5, this Figure shows a schematic diagram depicting a software architecture and process flow for a computer vision program that may be stored in non-volatile memory and executed by the processor of the computing device of the system of FIG. 4, using portions of volatile memory thereof. Initially, a captured image is received at the computer vision program from a camera associated with the computing device. The captured image is then transferred to an image processing pipeline, which extracts features from the image, and applies a run-time classifier to the extracted features in order to make an output determination of whether the image includes an illuminated graphical display of a mobile computing device in a vicinity of a driver, such as in a front driver's side window of a vehicle. After the captured image is received, perspective correction is performed on the image to transform the image from a perspective view taken from a vantage point above the vehicle, to a view that appears as if it was taken from directly to the side of the vehicle. In this manner, subsequent processing, such as identifying circular wheel shapes may be performed with more processing efficiently. One example of perspective correction is show in FIG. 6.

Following perspective correction, vehicle boundary detection and background removal may be performed. One approach to performing these steps is to compare a current frame against a prior frame in a successive series of captured images for changes in the values of pixels outside of a permissible range, and to remove contiguous groups of pixels that have not changed more than the permissible range (i.e., more than a subtraction threshold). In this manner, relatively unchanging background pixels may be removed from the image, and pixels that have recently changed may be kept. For moving vehicles against a relatively still background, this should result in an image that only includes the moving vehicle. Filtering can also be performed to require a minimum size for elements that may remain in the image, which can be used to filter out smaller objects such as birds, people, etc. walking through the field of view of the camera. One example of background removal using pixel these techniques is shown in FIG. 6, which shows a tree has been removed from the image. Alternatively, the background subtraction step based on motion may be skipped and techniques such as edge detection may be used to identify a perimeter of the vehicle and remove the background.

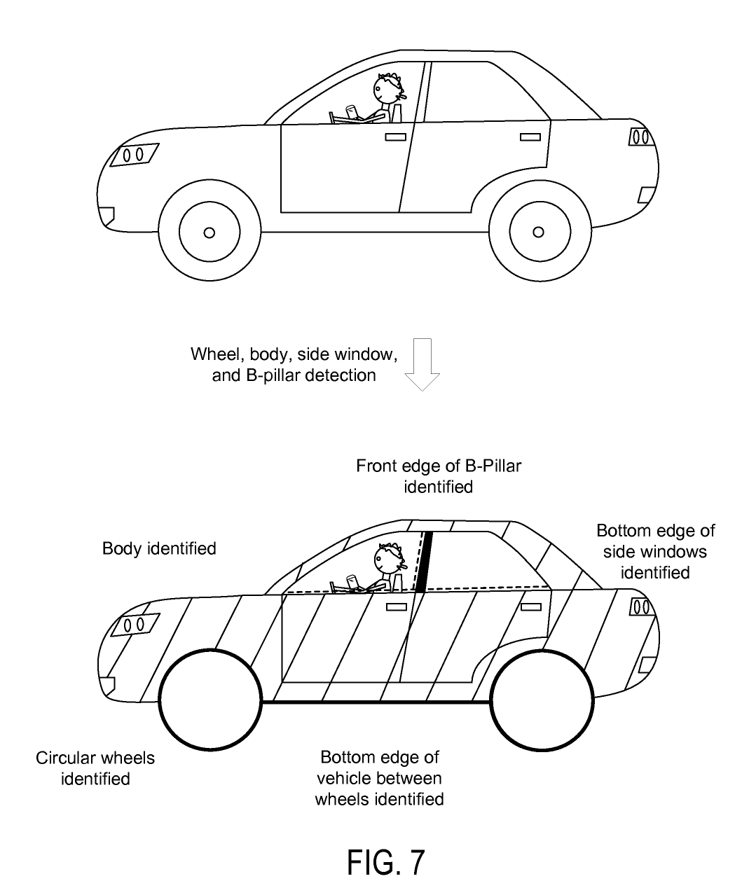

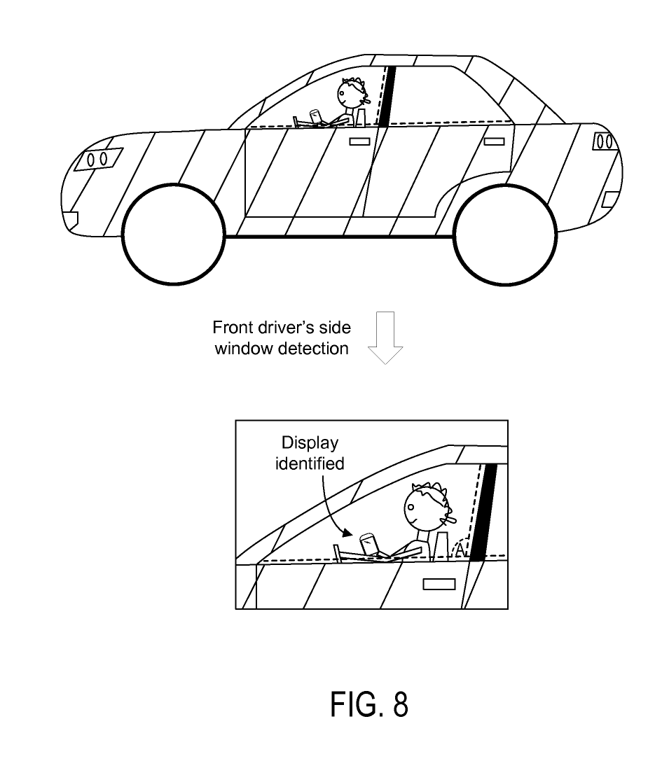

Following removal of the background, the computing device proceeds to identify individual features of the vehicle. First, an edge detection algorithm, such a differential edge detector based on pixel characteristic gradients, as described above. By examining color gradients, in particular, the circular edge formed by the contrasting colors of the wheels and tires of the vehicle can be identified. The same edge detector may be applied to identify the side windows and B-pillar, since the color gradient between the painted body and the side windows will tend to be sharply defined. The area not occupied by the wheels and side windows may be classified as body. Other approaches to identifying the body may also be used, such as blob detection based upon color clustering. Using a color clustering approach, contiguous regions of pixels having color values within a predefined range may be deemed to be part of the body of the vehicle, since body panels are typically painted a single color across the vehicle. Color clustering approaches may also be used to identify the wheels and tires (tires being black and wheels being silver or grey in most cases). Glints from sunlight may frustrate such approaches, but can be identified and filtered out based on their unique color and brightness profiles. The B-pillar of the vehicle in the captured image is also identified using edge detection techniques, the B-Pillar nearly always being the same color as the body paint, or black. In particular, the front edge of the B-Pillar is identified. In addition, a bottom edge of the front window is identified. From camera placement, the computing device knows a priori that the side of the vehicle facing the camera is the driver's side. Further, based on the motion of the vehicle between the captured frames, and also from the position of the camera, the computing device knows the direction of travel of the vehicle. Based on this, the computing device identifies a front driver's side window as a region within the identified window, forward of the front edge of the B-Pillar and above the bottom edge of the side windows. FIG. 7 illustrates an example of the wheels, body, side windows, and B-Pillar detection as described above. FIG. 8 illustrates an example of front driver's side window detection based on the detected front edge of the B-Pillar and the bottom edge of the front driver's side window, with angle A as shown being formed at the intersection of the two edges.

Once these features have been extracted, the computing device examines within the region identified as the front driver's side window (i.e., forward of the front edge of the B Pillar and above the bottom edge of the window but below the edge between the window and the body panel framing the window), to identify a signature pixel characteristic indicative of the presence of an illuminated graphical display of a mobile computing device. For example, regions having defined edges with low entropy and a sharp gradient, brightness values within the region that are higher than a surrounding area, and edges that form a quadrilateral (or a rectangle if perspective adjustment techniques are performed to produce an image of the display from a viewing angle orthogonal to the display) of a predefined aspect ratio, may be identified as an illuminated graphical display. In addition, the color temperature of the pixels within such an identified region may be examined. It will be appreciated that many displays have a slightly bluish hue, having white color temperatures above 5000k. If a color temperature above 5000K (and in some embodiments above 6500K, and in other embodiments above 7500K) is found for a threshold number of pixels within the image, in combination with one or more of the aforementioned factors, then the region of interest may be identified as a graphical user interface of a display. It will be appreciated that when machine learning techniques are applied, such as a support vector machine, vectors representing each identified feature are fed into the machine and a classifier built based upon the training data. however, classifiers may also be purpose built using other than machine learning techniques, and the above features may be examined to determine whether an illuminated graphical display is present in a vicinity of a driver.

Accordingly, once the features described above are extracted, they may be fed into a run-time classifier for analysis. The run-time classifier is a program that has been trained using machine learning techniques, on a training data set of tagged images. The training data set includes the image data itself (typically a pair of images taken a predetermined time period apart), the extracted features for the pair of images, and a metadata tag for each pair of images indicating a correct output determination (i.e., whether or not an illuminated graphical display of a mobile computing device is present in a front driver's side window of a vehicle in a captured image). Typically the latter of the pair of captured images is examined for the features discussed above in relationship to FIG. 5, and the earlier image in the pair is used for a pixel value change (i.e., motion) comparison and background subtraction. The data set may be fed into a program configured to implement a machine learning algorithm such as support vector machine. The machine learning algorithm generates a run-time classifier, which is then executed by the computing device at run-time to produce an output determination for each captured image (or pair of captured images) captured at run time. FIG. 8 illustrates an example of a display being identified based upon the above discussed signature pixel characteristics.

It will be appreciated that other camera locations apart from those shown in FIG. 1 may be utilized, with appropriate perspective correction. For example, cameras may be positioned on overpasses, bridges, buildings, street signs, or at other elevated locations that provide a vantage into a vehicles windows from above. Further, although the subject application has primarily discussed examination of side views of the vehicle, it will be appreciated that views from overpasses, traffic signals, and the like can afford a view of the user's lap through the front window of the vehicle (see, e.g., camera 124 in FIG. 1). Thus, it will be appreciated that the techniques described herein may be equally applied to images of illuminated graphical displays captured through a front window of a vehicle.

Further, in some embodiments, the camera may be mounted in the vehicle itself, such as in the ceiling, and the computing device may be positioned on board the vehicle. The dashed lines in FIG. 2 illustrated the field of view of such a camera placement. In this embodiment, the computing device may examine the captured image to determine whether an illuminated graphical display is present in the vicinity (i.e., lap region) of the driver, and if so, may send an output determination that causes an alert or alarm to be presented within the vehicle. The alert or alarm may, for example be presented via an onboard radio unit or dashboard indicator. Or, if a BLUETOOTH or other connection is available between the vehicle and the mobile computing device, then a command may be sent to disable a display of the device.

It will be appreciated that in addition to capturing an image when sensors 130 and 132 detect the presence of a vehicle, in other embodiments, computer vision techniques may be used on a stream of continuously capture images, and when an output determination is made on a frame that includes an illuminated graphical display in the vicinity of the driver, the system may be configured to recognize the numbers and letters on the license plate (LP, see FIG. 1) of the vehicle. If the current frame does not provide a clear view of the license plate, then the computing device may use motion tracking to track the vehicle over a series of frames until an image is identified in which the numbers and letters on the license plate can be clearly recognized. Alternatively, streams from multiple cameras can be synchronized and when an illuminated graphical display is identified in the vicinity of a driver in a frame of a first stream (such as a stream from overhead camera 124 or side camera 120, then a frame from a second stream (such as overhead camera 122) clearly showing the license plate may be referenced and paired with the frame from the first stream, and the license plate data may be recognized from the frame from the second stream. The image pair consisting of the image showing eh display from the first stream and the image showing the recognized license plate from the second stream may be sent to appropriate authorities for examination and issuance of any appropriate sanctions.

In addition, while a four door sedan is illustrated in the Figures, and discussion is included above regarding identification of a B-Pillar and front driver's side window, it will be appreciated that the techniques described herein may be applied to coupes, pick-up trucks, and other vehicles lacking a B-Pillar. For such vehicles, the driver's side window is identified by identifying the perimeter edges of the driver's side window, using gradient based edge detection techniques as described above, for example. Apart from this difference, the same techniques described above may be applied to identify whether or not an illuminated graphical display is present within the driver's side window.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for detecting presence of a graphical display of a mobile device within a motor vehicle, comprising:
capturing an image of a vehicle being operated on a public roadway; determining a location of a driver's seat region of the vehicle within the image; detecting the presence of an illuminated graphical display in the driver's seat region of the vehicle in the image, the presence of the graphical display being detected by:
processing the image to identify a signature pixel characteristic indicative of a graphical display in the driver's seat region of the vehicle in the image; and
outputting an indication of a positive detection of the graphical display.

2. The method of claim 1, wherein the signature pixel characteristic includes one or more of a hue, value, chroma, brightness, and/or luminosity.

3. The method of claim 1, wherein outputting the indication includes presenting the image via a graphical display for inspection by personnel.

4. The method of claim 1, wherein outputting the indication includes transmitting image data including the image to a remote computing device via a communication network.

5. The method of claim 1, wherein outputting the indication includes mailing the image to a mailing address associated with the vehicle along with a government issued citation.

6. The method of claim 1, wherein the image is a first image, the method further comprising:
capturing a second image from a different perspective than the first image, the different perspective enabling a license plate of the vehicle to be visible in the second image; and
presenting the second image or outputting an identifier of the license plate captured in the second image responsive to positive detection of the graphical display.

7. The method of claim 1, further comprising:
detecting the driver's position within the vehicle frame of reference by:
processing the image to identify a window of the vehicle; and
outputting the indication of the positive detection only if the graphical display is present within an interior region of the window corresponding to the driver's seat region of the vehicle.

8. The method of claim 1, wherein processing the image includes applying edge detection algorithms to the image to identify characteristic shape of the graphical display.

9. The method of claim 1, wherein processing the image includes applying a filter to the image to identify the signature pixel characteristic including one or more of a hue, value, chroma, brightness, and/or luminosity.

10. The method of claim 1, wherein capturing the image is performed responsive to satisfaction of a trigger condition, the trigger condition indicating the presence of the vehicle.

11. The method of claim 1, further comprising:
processing the image to identify a finger of the driver obstructing a portion of the graphical display.

12. A system for detection of a driver's mobile device use while operating a motor vehicle, comprising:
a camera positioned to capture an image of a driver's side of a motor vehicle while the vehicle is being operated on a public roadway;
a computing device being configured to receive the image from the camera, and process the image to identify a graphical display of a mobile device being operated by the driver of the vehicle.

13. The system of claim 12, wherein the computing device is configured to process the image by detecting a signature pixel characteristic selected from the group consisting of hue, value, chroma, brightness, and luminosity.

14. The system of claim 12, wherein the computing device is further configured to process the image by identifying a target region of the image at which the driver's side window is located.

15. The system of claim 14, wherein the computing device is configured to identify the target region by extracting features of the vehicle including detected wheels and/or outline of the vehicle, and locating the estimated position of the driver's side window based on the extracted features.

16. The system of claim 12, wherein the computing device is further configured to process the image by identifying the signature pixel characteristic in each of a plurality of contiguous pixels covering at least a threshold area within the image.

17. The system of claim 12, further comprising:
a sensor configured to sense a predetermined position of the motor vehicle; a controller being configured to receive a signal from the sensor indicating the motor vehicle is in the predetermined position, and in response to send a signal to the camera to cause the camera to capture the image.

18. The system of claim 17, wherein the controller is configured to associate meta data with the image including location and time.

19. A system for detecting presence of a graphical display of a mobile device within a motor vehicle, comprising:
a first camera to capture a first image of a scene from a first perspective; a second camera to capture a second image of the scene from a second perspective;
a computing system configured to:
receive the first image and the second image from the first camera and the second camera; detect presence of a graphical display within the scene by processing the first image to identify a signature pixel characteristic indicative of the graphical display in a portion of the scene corresponding to a driver's position within a vehicle frame of reference, the signature pixel characteristic including one or more of a hue, value, chroma, brightness, and/or luminosity; transmit the second image to a remote computing device via a communication network, or present the second image responsive to a positive detection of the graphical display responsive to a positive detection of the graphical display.

20. The system of claim 19, wherein the computing device is further configured to process the first image by identifying a target region of the image at which the driver's side window is located.
